(19) United States
(12) Patent Application Publication
(10) Pub. No.: US 2025/0103736 A1
(43) Pub. Date: Mar. 27, 2025

(54) ELECTRONIC DOCUMENT MANAGEMENT SYSTEM, NON-TRANSITORY COMPUTER READABLE MEDIUM STORING ELECTRONIC DOCUMENT MANAGEMENT PROGRAM, AND ELECTRONIC DOCUMENT MANAGEMENT METHOD

(71) Applicant: FUJIFILM Business Innovation Corp., Tokyo (JP)

(72) Inventor: Hirochika SHIONOIRI, Kanagawa (JP)

(73) Assignee: FUJIFILM Business Innovation Corp., Tokyo (JP)

(21) Appl. No.: 18/595,418

(22) Filed: Mar. 5, 2024

(30) Foreign Application Priority Data
Sep. 26, 2023 (JP) 2023-162887

(51) Int. Cl. G06F 21/62

(52) U.S. Cl. CPC G06F 21/6209

(57) ABSTRACT

An electronic document management system includes plural devices that each store a distributed ledger and are communicably connected to each other, and a transaction generation device that includes a first processor and generates a transaction recorded in the distributed ledger, in which the first processor is configured to generate a document generation transaction in a case where an electronic document is generated and stored in a document management server, the document generation transaction including a document ID for uniquely identifying the electronic document, a transaction ID for uniquely identifying the document generation transaction, and information indicating that the document generation transaction is the document generation transaction, transmit the document generation transaction to the plural devices and record the document generation transaction in the distributed ledger, generate a usage permission transaction in response to a usage permission instruction for permitting a usage user to use the electronic document stored in the document management server, the usage permission transaction including the document ID of the electronic document, a transaction ID for uniquely identifying the usage permission transaction, a usage user ID for uniquely identifying the usage user, a usage permission time at which the usage permission instruction is received, and a parent transaction ID for uniquely identifying a parent transaction that is a transaction related to another process executed on the electronic document related to the usage permission instruction immediately before the usage permission instruction, and transmit the usage permission transaction to the plural devices and record the usage permission transaction in the distributed ledger.

### CROSS-REFERENCE TO RELATED APPLICATIONS

This application is based on and claims priority under 35 USC 119 from Japanese Patent Application No. 2023-162887 filed Sep. 26, 2023.

### BACKGROUND

### (i) Technical Field

The present invention relates to an electronic document management system, a non-transitory computer readable medium storing an electronic document management program, and an electronic document management method.

### (ii) Related Art

JP2005-135072A discloses a secure document exchange system including a user information database that stores an original document of a document exchanged between clients, and a property file that includes information such as an access authority to the document or a route definition for each client, in which a workflow related to the document is set based on the user information database and the property file.

### SUMMARY

An electronic document management system is considered in which an electronic document is stored in a document management server and a user is allowed to use the electronic document by accessing the electronic document. In this electronic document management system, a large number of unspecified users may be able to access the electronic document, and thus it may be necessary to appropriately manage the access authority to each electronic document.

However, setting the access authority for each electronic document managed by the document management server may be quite time and effort consuming.

Aspects of non-limiting embodiments of the present disclosure relate to an electronic document management system, a non-transitory computer readable medium storing an electronic document management program, and an electronic document management method that can verify whether or not a user can use an electronic document without setting an access authority for each electronic document in an electronic document management system that stores the electronic document in a document management server and allows the user to use the electronic document by accessing the electronic document.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an electronic document management system including a plurality of devices that each store a distributed ledger and are communicably connected to each other, and a transaction generation device that includes a first processor and generates a transaction recorded in the distributed ledger, in which the first processor is configured to generate a document generation transaction in a case where an electronic document is generated and stored in a document management server, the document generation transaction including a document ID for uniquely identifying the electronic document, a transaction ID for uniquely identifying the document generation transaction, and information indicating that the document generation transaction is the document generation transaction, transmit the document generation transaction to the plurality of devices and record the document generation transaction in the distributed ledger, generate a usage permission transaction in response to a usage permission instruction for permitting a usage user to use the electronic document stored in the document management server, the usage permission transaction including the document ID of the electronic document, a transaction ID for uniquely identifying the usage permission transaction, a usage user ID for uniquely identifying the usage user, a usage permission time at which the usage permission instruction is received, and a parent transaction ID for uniquely identifying a parent transaction that is a transaction related to another process executed on the electronic document related to the usage permission instruction immediately before the usage permission instruction, and transmit the usage permission transaction to the plurality of devices and record the usage permission transaction in the distributed ledger.

### BRIEF DESCRIPTION OF THE DRAWINGS

Exemplary embodiment(s) of the present invention will be described in detail based on the following figures, wherein:

FIG. 1 is a schematic configuration diagram of an electronic document management system according to the present exemplary embodiment;

FIG. 2 is a conceptual diagram showing a structure of a blockchain;

FIG. 3 is a schematic configuration diagram of an image processing device according to the present exemplary embodiment;

FIG. 4 is a conceptual diagram showing a content of a document generation transaction;

FIG. 5 is a conceptual diagram showing a content of a usage permission transaction;

FIG. 6 is a schematic configuration diagram of a document management server according to the present exemplary embodiment;

FIG. 7 is a schematic configuration diagram of a verification server according to the present exemplary embodiment;

FIG. 8 is a conceptual diagram showing a content of a cancellation transaction;

FIG. 9 is a first flowchart showing a flow of a process of the image processing device according to the present exemplary embodiment;

FIG. 10 is a second flowchart showing a flow of a process of the image processing device according to the present exemplary embodiment; and

FIG. 11 is a second flowchart showing a flow of a process of the verification server according to the present exemplary embodiment.

### DETAILED DESCRIPTION

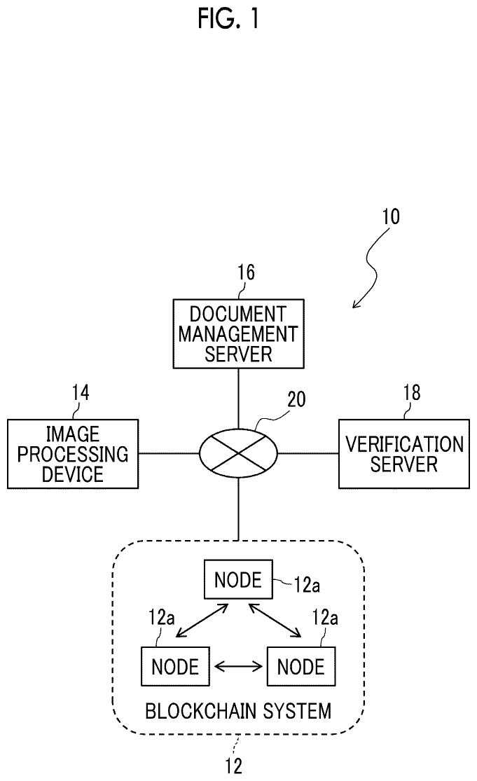

FIG. 1 is a schematic configuration diagram of an electronic document management system 10 according to the present exemplary embodiment. The electronic document management system 10 includes a blockchain system 12, an image processing device 14, a document management server 16, and a verification server 18. The blockchain system 12, the image processing device 14, the document management server 16, and the verification server 18 are communicably connected to each other via a communication line 20 such as a local area network (LAN) or a wide area network (WAN). In FIG. 1, only one image processing device 14 is shown, but the electronic document management system 10 may include a plurality of image processing devices 14.

The electronic document management system 10 is a system that manages an electronic document in response to an instruction from a user and allows the user to use the managed electronic document in response to the instruction from the user. Although details will be described later, in the electronic document management system 10, the electronic document is stored in the document management server 16, and pieces of information regarding the generation of the electronic document and the usage permission of the electronic document by the user are recorded in the blockchain as a transaction as a distributed ledger. By managing such a transaction in the blockchain, tampering with the transaction is suppressed, and it is possible to verify whether or not the user can use the electronic document without setting an access authority for each electronic document stored in the document management server 16. The blockchain system 12 includes a plurality of nodes 12a. Each node 12a may be any device as long as a memory and a processor are provided. For example, each node 12a may be a personal computer (PC), a server, or a multifunction machine. At least one of the image processing device 14, the document management server 16, or the verification server 18 may be the node 12a of the blockchain system 12. It should be noted that, in FIG. 1, only three nodes 12a constituting the blockchain system 12 are shown, but the blockchain system 12 may include three or more nodes 12a. The nodes 12a are communicably connected to each other by peer to peer (P2P) via a communication line such as a LAN or a WAN. The P2P is a communication method in which devices directly communicate with each other without using a server.

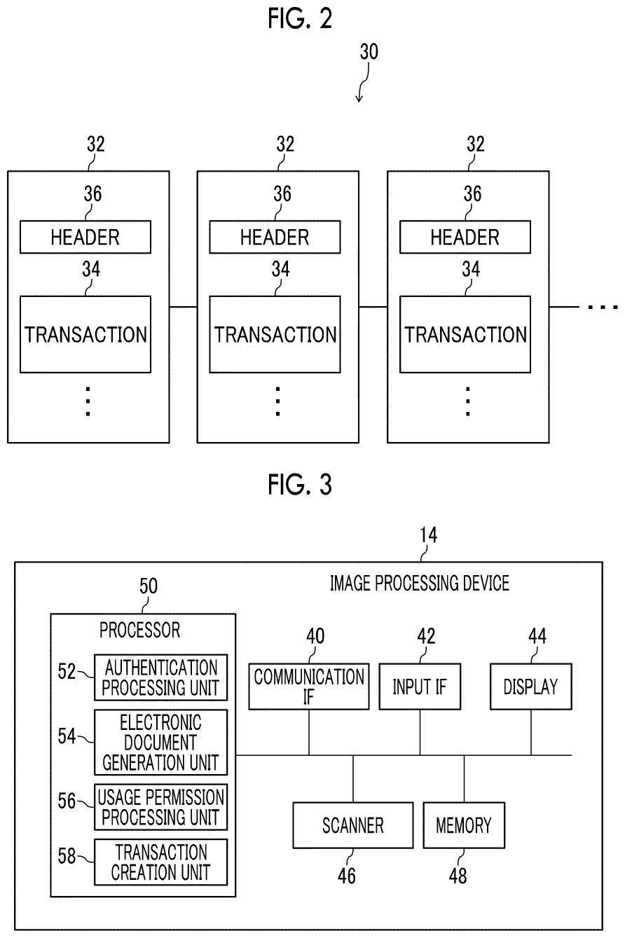

FIG. 2 is a conceptual diagram showing a structure of a blockchain 30. The blockchain 30 is a form of a distributed database in which a plurality of blocks are connected to each other. The distributed database here refers that the identical content of the blockchain 30 is stored in each node 12a. Each block 32 constituting the blockchain 30 includes a transaction 34 and a header 36. As described above, in the present exemplary embodiment, each transaction 34 is the information regarding the generation or the usage permission of the electronic document stored in the document management server 16. Details of the content of the transaction 34 will be described later. The header 36 includes a hash value of block information of an immediately previous block 32 that is a block 32 added to the blockchain 30 last time (hereinafter, referred to as a hash value of the block 32 for convenience). The block information is information including the transaction 34 and the like included in the block 32. The hash value is a value obtained by irreversibly converting target data (here, the block information of the immediately previous block 32). Therefore, in a case where the transaction 34 included in a certain block 32 is lost or tampered with, the hash values included in all the subsequent blocks 32 are different from the normal hash value. With such a mechanism, the loss or tampering of the transaction 34 (information regarding the generation or the usage permission of the electronic document in the present exemplary embodiment) is suppressed.

In a case where the block can be easily added to the blockchain, a malicious user can easily add an unauthorized block (for example, a block including tampered transaction) to the blockchain. Therefore, in the blockchain, it is common that a constraint for adding a new block is provided. One such constraint is an algorithm called proof of work (PoW). The PoW is a mechanism in which the node of the blockchain repeats a calculation, and in a case where a calculation result satisfies a predetermined condition, a new block is permitted to be added to the blockchain. In the blockchain 30 according to the present exemplary embodiment, the PoW is also used as a constraint for adding a new block 32.

A process of adding a new block 32 to the blockchain 30 is called a mining process. In the mining process by the PoW, the processor of the node 12a calculates the hash value of the block 32 by inputting a combination value obtained by combining the block information of the latest block 32 already added to the blockchain 30, that is, one or more pieces of the transaction 34 included in the block 32, the hash value of the immediately previous block 32 of the block 32, and a value called a nonce, to a hash function. As the hash function, for example, a function such as SHA-256 is used. In a case where the calculated hash value is smaller than a predetermined threshold value (referred to as a difficulty target), the mining process is successful, and a new block 32 is permitted to be added to the blockchain 30. The hash value smaller than the threshold value is referred to as a correct answer hash value. In a case where the calculated hash value is equal to or larger than the threshold value, the processor of the node 12a changes the value of the nonce and recalculates the hash value. It should be noted that, due to the characteristics of the hash function, the output hash value greatly changes in a case where the input data (here, the value of the nonce) is slightly different. As described above, the processor of the node 12a repeatedly calculates the hash value while changing the value of the nonce until the hash value is smaller than the threshold value (in other words, until the correct answer hash value is obtained). Generally, the amount of calculation required to obtain the correct answer hash value is huge.

FIG. 3 is a schematic configuration diagram of the image processing device 14 as a transaction generation device. The image processing device 14 is a device having a print function, a copy function, a scan function, a FAX function, and the like, and is, for example, a multifunction peripheral. The image processing device 14 executes a process of generating the electronic document stored in the document management server 16 in response to an instruction from the user, a process of receiving the usage permission of the electronic document from one user to another user, and a process of generating the transaction 34 related to the electronic document. It should be noted that, in the present exemplary embodiment, the transaction generation device is the image processing device 14. However, the transaction generation device is not limited to the image processing device 14, and may be another device as long as the device can exhibit the following functions. For example, the transaction generation device may be a PC. Further, in the present exemplary embodiment, as will be described later, the electronic document stored in the document management server 16 is image data generated by a scanner 46 of the image processing device 14, but the electronic document may be another data. For example, the electronic document may be an electronic file or an image file generated by the PC.

The communication interface (IF) 40 is configured with, for example, a network adapter. The communication IF 40 exhibits a function of communicating with another device via the communication line 20.

An input IF 42 is configured with, for example, a button or a touch panel. The input IF 42 is used in a case where the user inputs an instruction to the image processing device 14.

A display 44 is configured with, for example, a liquid crystal display, an organic electro luminescent (EL) display, or the like. Various screens are displayed on the display 44 in response to an instruction from a processor 50 described later.

The scanner 46 is configured with a light source, an image sensor such as a charge-coupled device (CCD), or the like. The scanner 46 is a mechanism that executes the scan process of optically reading a paper medium to generate the electronic document. In the present exemplary embodiment, the electronic document generated by the scanner 46 is the electronic document stored in the document management server 16.

The memory 48 includes a hard disk drive (HDD), a solid state drive (SSD), an embedded multimedia card (eMMC), a read only memory (ROM), a random access memory (RAM), and the like. The memory 48 stores a transaction creation program as an electronic document management program for operating each unit of the image processing device 14. It should be noted that the transaction creation program can be stored in, for example, a computer readable non-transitory storage medium such as a universal serial bus (USB) memory or an SD card. The image processing device 14 can read and execute the transaction creation program from such a storage medium.

The processor 50 as a first processor is configured with, for example, a central processing unit (CPU). The processor 50 is communicably connected to the communication IF 40, the input IF 42, the display 44, the scanner 46, and the memory 48 via a data bus. The processor 50 exhibits functions as an authentication processing unit 52, an electronic document generation unit 54, a usage permission processing unit 56, and a transaction creation unit 58 by the electronic document management program stored in the memory 48.

The authentication processing unit 52 authenticates the user who uses the image processing device 14. For example, the image processing device 14 includes a card reader (not shown), and the authentication processing unit 52 authenticates the user by a user ID obtained by the card reader reading an ID card of the user. The authentication processing unit 52 may authenticate the user by causing the user to input the user ID and a password. The authentication processing unit 52 can authenticate the user to specify the user ID of the user.

The electronic document generation unit 54 generates the electronic document in response to the instruction from the user authenticated by the authentication processing unit 52. In the image processing device 14, the electronic document generation unit 54 generates the electronic document by causing the scanner 46 to scan the paper medium set by the user based on a scan job from the user. The electronic document generation unit 54 transmits the generated electronic document to the document management server 16 to store the electronic document in the document management server 16.

The usage permission processing unit 56 receives a usage permission instruction for permitting another user to use the electronic document stored in the document management server 16, from the user. In the present specification, a user who inputs the usage permission instruction, that is, a user who permits another user to use the electronic document is referred to as a permission user, and a user who is permitted to use the electronic document by the permission user is referred to as a usage user. The usage permission instruction includes a document ID of the electronic document related to the usage permission and a user ID of the usage user. In a case where the usage permission instruction is received, the usage permission processing unit 56 outputs, to the usage user related to the usage permission instruction, a permission notification including at least one of the document ID for uniquely identifying the electronic document for which the usage is permitted or a transaction ID for uniquely identifying a usage permission transaction (details will be described later) for the permission of the electronic document to the usage user. It should be noted that the permission notification may be directly transmitted to the usage user by the permission user by a separate method (for example, e-mail) instead of the usage permission processing unit 56.

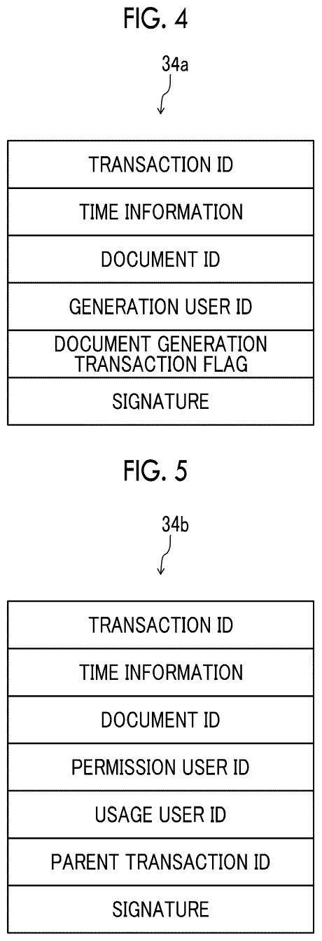

In a case where the electronic document generation unit 54 generates the electronic document and stores the electronic document in the document management server 16, the transaction creation unit 58 generates a document generation transaction that is the transaction 34 related to the document generation. FIG. 4 is a conceptual diagram showing a content of a document generation transaction 34a. The document generation transaction 34a includes the transaction ID, time information, the document ID, a generation user ID, a document generation transaction flag, and a signature.

Each information included in the document generation transaction 34a will be described. The transaction ID is an identifier for uniquely identifying the document generation transaction 34a. The transaction ID is decided by the transaction creation unit 58. The time information is information indicating a time at which the electronic document related to the document generation transaction 34a is generated. The document ID is an identifier for uniquely identifying the electronic document related to the document generation transaction 34a. The document ID is decided by the document management server 16. In a case where the electronic document generation unit 54 transmits the electronic document to the document management server 16, the document ID of the electronic document is transmitted from the document management server 16 to the image processing device 14. The transaction creation unit 58 includes the document ID transmitted from the document management server 16, in the document generation transaction 34a. The generation user ID is a user ID of the generation user who gives an instruction to generate the electronic document related to the document generation transaction 34a. The transaction creation unit 58 sets the user ID acquired by the authentication processing unit 52 before the process of generating the electronic document by the electronic document generation unit 54, as the generation user ID. The document generation transaction flag is information indicating that the transaction 34 is the document generation transaction 34a. The document generation transaction flag may be any information. For example, in a case where the document generation transaction 34a has the same data structure as a usage permission transaction 34b described later, the document generation transaction 34a may include the transaction ID thereof as the parent transaction ID (details will be described later) to indicate that the document generation transaction 34a is the document generation transaction. In a case where it is possible to grasp that the document generation transaction 34a is the document generation transaction 34a by the data structure of the document generation transaction 34a, the document generation transaction flag does not need to be provided in the document generation transaction 34a. In such a case, the data structure of the document generation transaction 34a itself is information indicating that the document generation transaction 34a is the document generation transaction 34a. The signature is data obtained by signing the transaction ID, the time information, the document ID, the generation user ID, and the document generation transaction flag by using a private key of the generation user.

The transaction creation unit 58 simultaneously transmits the generated document generation transaction 34a to the plurality of nodes 12a included in the blockchain system 12. As a result, in each node 12a, the mining process for the block 32 including the document generation transaction 34a is executed, and the block 32 including the document generation transaction 34a is added to the blockchain 30 in a case where the mining process is successful. That is, the document generation transaction 34a is recorded in the blockchain 30.

In addition, the transaction creation unit 58 generates the usage permission transaction that is the transaction 34 related to the usage permission instruction, in response to the usage permission instruction received by the usage permission processing unit 56. FIG. 5 is a conceptual diagram showing a content of the usage permission transaction 34b. The usage permission transaction 34b includes a transaction ID, time information, a document ID, a permission user ID, a usage user ID, a parent transaction ID, and a signature.

Each information included in the usage permission transaction 34b will be described. The transaction ID is an identifier for uniquely identifying the usage permission transaction 34b. The transaction ID is decided by the transaction creation unit 58. The time information is information indicating a time at which the usage permission instruction related to the usage permission transaction 34b is received. Since the electronic document is generated and stored in the document management server 16, and then the usage permission instruction for the electronic document is input by the permission user, in a case of the identical electronic document, the time indicated by the time information of the usage permission transaction 34b is a time later than the time indicated by the time information of the document generation transaction 34a. The document ID is an identifier for uniquely identifying the electronic document related to the usage permission transaction 34b. The transaction creation unit 58 includes the document ID included in the usage permission instruction received from the user, in the usage permission transaction 34b. The permission user ID is a user ID of the permission user. The transaction creation unit 58 sets the user ID acquired by the authentication processing unit 52 before the usage permission processing unit 56 receives the usage permission instruction, as the permission user ID. The usage user ID is a user ID of the usage user. The transaction creation unit 58 includes the usage user ID included in the usage permission instruction received from the user, in the usage permission transaction 34b. The parent transaction ID is an identifier for uniquely identifying a parent transaction that is the transaction 34 related to another process executed on the electronic document related to the usage permission instruction immediately before the usage permission instruction. Details of the method of deciding the parent transaction ID will be described later. The signature is data obtained by signing the transaction ID, the time information, the document ID, the permission user ID, the usage user ID, and the parent transaction ID by using a private key of the permission user. It should be noted that the usage permission transaction 34b does not have information such as a usage permission transaction flag, but it is possible to grasp that the usage permission transaction 34b is the usage permission transaction 34b by the data structure of the usage permission transaction 34b including the permission user ID and the usage user ID.

In the present specification, the document generation transaction 34a and the usage permission transaction 34b are collectively referred to as the transaction 34.

The method of deciding the parent transaction ID will be described. The transaction creation unit 58 searches for the transaction 34 including the document ID identical to the document ID included in the usage permission transaction 34b, from the transactions 34 included in the block 32 already added to the blockchain 30. In a case where a plurality of transactions 34 are searched for, the transaction 34 in which the time indicated by the time information is the most recent is specified. The transaction ID of such a transaction 34 is the parent transaction ID of the usage permission transaction 34b. The parent transaction may be the document generation transaction 34a or may be another usage permission transaction 34b.

The transaction creation unit 58 may set, for example, another usage permission transaction 34b including the document ID identical to the document ID included in the usage permission transaction 34b and including the user ID identical to the permission user ID included in the usage permission transaction 34b as the usage user ID, as the parent transaction ID of the usage permission transaction 34b. In other words, even in a case where the document ID identical to the document ID included in the usage permission transaction 34b is included, the transaction creation unit 58 does not set the transaction ID of another usage permission transaction 34b that does not include the usage user ID identical to the permission user ID included in the usage permission transaction 34b, as the parent transaction ID of the usage permission transaction 34b. Accordingly, in a case where a plurality of users give the usage permission instruction for the identical electronic document, a case where another usage permission transaction 34b that is not the usage permission transaction 34b related to the usage permission instruction for which the permission user related to the usage permission transaction 34b is permitted to use as the usage user is set as the parent transaction is suppressed. That is, the parent transaction ID of the usage permission transaction 34b can be more accurately decided.

In addition, for example, in a case where the transaction 34 that includes the document ID identical to the document ID included in the usage permission transaction 34b and in which the time indicated by the time information is the most recent is the document generation transaction 34a, that is, in a case where another usage permission transaction 34b related to the document ID is not searched for, in a case where the document generation transaction 34a includes the user ID identical to the permission user ID included in the usage permission transaction 34b as the generation user ID, the transaction creation unit 58 may set the transaction ID of the document generation transaction 34a as the parent transaction ID of the usage permission transaction 34b. In other words, in a case where the generation user ID of the specified document generation transaction 34a is different from the permission user ID included in the usage permission transaction 34b, the transaction creation unit 58 does not set the transaction ID of the document generation transaction 34a as the parent transaction ID of the usage permission transaction 34b. Accordingly, for example, even in a case where the document generation transaction 34a including the document ID identical to the document ID included in the usage permission transaction 34b is included in the blockchain 30 by a malicious user, a case where the document generation transaction 34a is set as the parent transaction is suppressed. That is, the parent transaction ID of the usage permission transaction 34b can be more accurately decided.

The transaction creation unit 58 simultaneously transmits the generated usage permission transaction 34b to the plurality of nodes 12a included in the blockchain system 12. Accordingly, in each node 12a, the mining process for the block 32 including the usage permission transaction 34b is executed, and the block 32 including the usage permission transaction 34b is added to the blockchain 30 in a case where the mining process is successful. That is, the usage permission transaction 34b is recorded in the blockchain 30.

In addition, the transaction creation unit 58 may notify, for example, the permission user of the transaction ID of the generated usage permission transaction 34b.

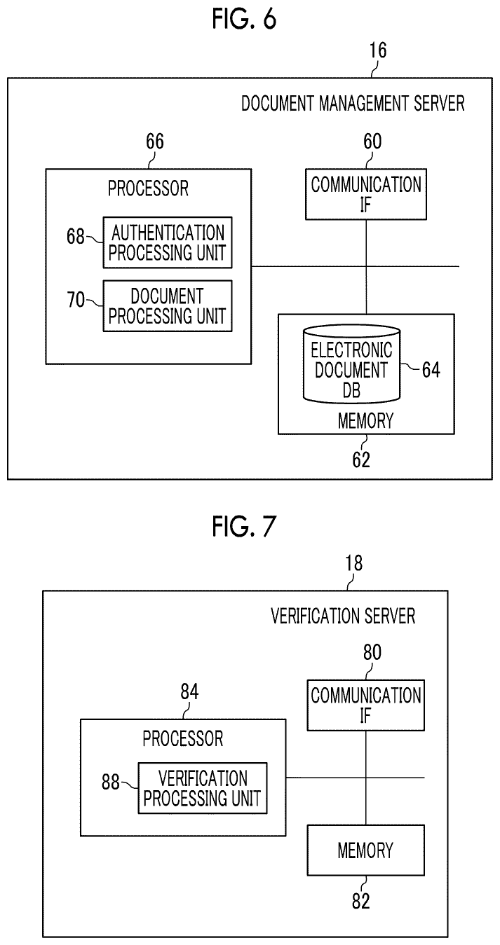

FIG. 6 is a schematic configuration diagram of the document management server 16.

The communication IF 60 is configured with, for example, a network adapter. The communication IF 60 exhibits a function of communicating with another device via the communication line 20.

The memory 62 includes an HDD, an eMMC, a ROM, a RAM, or the like. The memory 62 stores a program for operating each unit of the document management server 16. It should be noted that the program can be stored in, for example, a computer-readable non-transitory storage medium such as a USB memory or an SD card. The document management server 16 can read and execute the program from such a storage medium. As shown in FIG. 6, an electronic document database (DB) 64 is provided in the memory 62. The electronic document DB stores the electronic document transmitted from one or more image processing devices 14 included in the electronic document management system 10.

The processor 66 is configured with, for example, a CPU. The processor 66 is communicably connected to the communication IF 60 and the memory 62 via a data bus. The processor 66 exhibits a function as an authentication processing unit 68 and a document processing unit 70 by the program stored in the memory 62.

The authentication processing unit 68 authenticates the user who uses the document management server 16. For example, the document management server 16 authenticates the user by causing the user to input the user ID and the password. The authentication processing unit 68 can authenticate the user to specify the user ID of the user.

The document processing unit 70 executes a process related to the electronic document managed by the electronic document management system 10. In a case where the electronic document is received from the image processing device 14, the document processing unit 70 stores the electronic document in the electronic document DB 64 with the document ID and transmits the document ID to the image processing device 14. In a case where the document processing unit 70 receives a usage request for the electronic document managed by the document management server 16 from the user authenticated by the authentication processing unit 68, the document processing unit 70 transmits a verification request for requesting verification of whether or not the user can use the electronic document to the verification server 18. The verification request includes at least one of the user ID of the user and the document ID of the electronic document acquired by the authentication processing unit 68, or the transaction ID of the usage permission transaction 34b related to the usage permission of the electronic document. The verification process by the verification server 18 will be described later.

In the present exemplary embodiment, the image processing device 14 has the function of the usage permission processing unit 56, and the permission user inputs the usage permission instruction to the image processing device 14. However, the document management server 16 may have the function of the usage permission processing unit 56, and the permission user may input the usage permission instruction to the document management server 16. In this case, the processor 66 may exhibit a part of the functions of the transaction creation unit 58. The processor 66 may generate the usage permission transaction 34b related to the usage permission instruction, in response to the usage permission instruction received from the user, and may simultaneously transmit the generated usage permission transaction 34b to the plurality of nodes 12a included in the blockchain system 12. As described above, the processor 66 may exhibit a part of the functions of the first processor.

FIG. 7 is a schematic configuration diagram of the verification server 18 as a verification device.

The communication IF 80 is configured with, for example, a network adapter. The communication IF 80 exhibits a function of communicating with another device via the communication line 20.

The memory 82 includes an HDD, an eMMC, a ROM, a RAM, or the like. The memory 82 stores a verification program for operating each unit of the verification server 18. It should be noted that the verification program can be stored in, for example, a computer-readable non-transitory storage medium such as a USB memory or an SD card. The verification server 18 can read and execute the verification program from such a storage medium.

The processor 84 as a second processor is configured with, for example, a CPU. The processor 84 is communicably connected to the communication IF 80 and the memory 82 via a data bus. The processor 84 exhibits a function as a verification processing unit 88 by the verification program stored in the memory 82.

The verification processing unit 88 verifies whether or not to permit the user indicated by the user ID included in the verification request to use the electronic document indicated by the document ID or the transaction ID included in the verification request, in response to the reception of the verification request from the document management server 16.

First, in a case where the verification request including the document ID and the user ID is received, the verification processing unit 88 searches for the usage permission transaction 34b including the document ID included in the verification request and the user ID included in the verification request as the usage user ID, from the transactions 34 included in the block 32 already added to the blockchain 30. In a case where a plurality of the usage permission transactions 34b are searched for, the usage permission transaction 34b in which the time indicated by the time information is the most recent is specified. In the present specification, such a usage permission transaction 34b is referred to as a latest usage permission transaction 34b.

In a case where the verification request including the transaction ID is received, the verification processing unit 88 searches for the usage permission transaction 34b including the transaction ID included in the verification request, from the transactions 34 included in the block 32 already added to the blockchain 30. The usage permission transaction 34b also includes the document ID of the electronic document related to the usage request input to the document management server 16 by the user, and the user ID of the user as the usage user ID. In the present specification, the usage permission transaction 34b specified based on the transaction ID included in the verification request is also referred to as the latest usage permission transaction 34b.

At this point in time, in a case where the latest usage permission transaction 34b cannot be specified from the blockchain 30, the verification processing unit 88 does not permit the user to use the electronic document. In a case where the user is not permitted to use the electronic document, the verification processing unit 88 transmits the verification result to the document management server 16, and the document management server 16 notifies the user of the verification result.

Then, the verification processing unit 88 specifies the transaction 34 including the parent transaction ID included in the specified latest usage permission transaction 34b as the transaction ID, from the transactions 34 included in the block 32 already added to the blockchain 30. In a case where the specified transaction 34 is the usage permission transaction 34b, the verification processing unit 88 further specifies the transaction 34 including the parent transaction ID included in the usage permission transaction 34b as the transaction ID, from the transactions 34 included in the block 32 already added to the blockchain 30. As described above, the verification processing unit 88 traces the parent transaction with the latest usage permission transaction 34b as a starting point, based on the parent transaction ID included in the usage permission transaction 34b in the blockchain 30.

Here, in order to more reliably specify the parent transaction ID, the verification processing unit 88 may specify, for example, the transaction 34 including the parent transaction ID included in the usage permission transaction 34b as the transaction ID and including the document ID identical to the document ID of the usage permission transaction 34b, as the parent transaction of the usage permission transaction 34b. Further, the verification processing unit 88 may specify, for example, the document generation transaction 34a including the parent transaction ID included in the usage permission transaction 34b as the transaction ID and including the user ID identical to the permission user ID of the usage permission transaction 34b as the generation user ID, or another usage permission transaction 34b including the parent transaction ID included in the usage permission transaction 34b as the transaction ID and including the user ID identical to the permission user ID of the usage permission transaction 34b as the usage user, as the parent transaction of the usage permission transaction 34b.

Then, in a case where the verification processing unit 88 traces the parent transaction with the latest usage permission transaction 34b as a starting point and reaches the document generation transaction 34a of the electronic document as a result, the verification processing unit 88 permits the user to use the electronic document. Whether or not the document generation transaction 34a is reached can be determined by whether or not the parent transaction includes the document generation transaction flag. Even in a case where the user is not permitted to use the electronic document, the verification processing unit 88 transmits the verification result to the document management server 16, and the document management server 16 notifies the user of the verification result.

On the other hand, in a case where the verification processing unit 88 traces the parent transaction with the latest usage permission transaction 34b as a starting point and does not reach the document generation transaction 34a of the electronic document, the verification processing unit 88 does not permit the user to use the electronic document. The fact that the document generation transaction 34a of the electronic document is not reached indicates that the usage permission transaction 34b in a path from the generation of the electronic document to the permission for the user to use the electronic document is tampered with or is an unauthorized usage permission transaction 34b. Therefore, in this case, since there is a possibility that the usage permission of the electronic document for the user is unauthorized or the electronic document is transmitted to the user on an unauthorized path, the verification processing unit 88 does not permit the user to use the electronic document.

As described above, in the electronic document management system 10 according to the present exemplary embodiment, in a case where the electronic document is generated and the permission user permits the usage user to use the electronic document, the usage permission transaction 34b including the parent transaction ID is recorded in the blockchain 30. As a result, in the electronic document management system 10, it is possible to verify whether or not the user can use the electronic document without setting the access authority for each electronic document.

After the permission user permits the usage user to use the electronic document stored in the document management server 16, the permission user may want to cancel the permission. As described above, in a case where the permission user permits the usage user to use the electronic document, the usage permission transaction 34b is generated and recorded in the blockchain 30. Due to the characteristics of the blockchain 30, even the permission user cannot delete the usage permission transaction 34b (including the block 32) recorded in the blockchain 30 once from the blockchain 30.

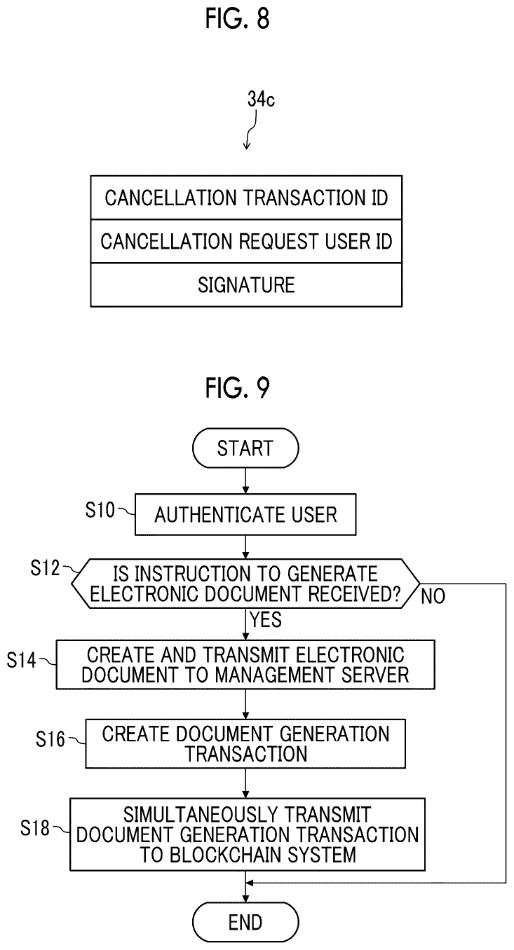

Therefore, in the present exemplary embodiment, the permission user who wants to cancel the permission related to the usage permission transaction 34b already recorded in the blockchain 30 inputs a cancellation instruction to the image processing device 14. The cancellation instruction includes the transaction ID of the usage permission transaction 34b to be canceled. The transaction creation unit 58 creates a cancellation transaction in response to the cancellation instruction. FIG. 8 is a conceptual diagram showing a content of the cancellation transaction 34c. The cancellation transaction 34c includes a cancellation transaction ID, a cancellation request user ID, and a signature.

The cancellation transaction ID is a transaction ID of the usage permission transaction 34b related to the cancellation instruction. The transaction creation unit 58 sets the transaction ID included in the cancellation instruction as the cancellation transaction ID. The cancellation request user ID is a user ID of the permission user who inputs the cancellation instruction. The transaction creation unit 58 sets the user ID acquired by the authentication processing unit 52 before the cancellation instruction is received, as the cancellation request user ID. The signature is data signed by using a secret key of the permission user who inputs the cancellation transaction ID and the cancellation instruction of the cancellation request user ID.

The transaction creation unit 58 simultaneously transmits the generated cancellation transaction 34c to the plurality of nodes 12a included in the blockchain system 12. As a result, in each node 12a, the mining process for the block 32 including the cancellation transaction 34c is executed, and the block 32 including the cancellation transaction 34c is added to the blockchain 30 in a case where the mining process is successful. That is, the cancellation transaction 34c is recorded in the blockchain 30.

The verification processing unit 88 of the verification server 18 does not permit the usage user to use the electronic document in a case where the parent transaction is traced with the latest usage permission transaction 34b as a starting point in the blockchain 30 in response to the usage request for the electronic document from the usage user, and the usage permission transaction 34b including the transaction ID identical to the cancellation transaction ID is searched for from the traced usage permission transaction 34b. Specifically, the verification processing unit 88 extracts the cancellation transaction 34c included in the blockchain 30 before the verification process. Then, the cancellation transaction ID included in the extracted cancellation transaction 34c is held. Then, the verification processing unit 88 determines whether or not the transaction ID of the specified parent transaction matches the held cancellation transaction ID each time the parent transaction is specified, with the latest usage permission transaction 34b as a starting point.

The outline of the electronic document management system 10 according to the present exemplary embodiment is as described above. Hereinafter, a flow of a process of the electronic document management system 10 will be described with reference to the flowcharts shown in FIGS. 9 to 11.

FIG. 9 is a flowchart showing a flow of a process in which the image processing device 14 creates and transmits the document generation transaction 34a.

In step S10, the authentication processing unit 52 authenticates the user. As a result, the authentication processing unit 52 acquires the user ID of the user.

In step S12, the electronic document generation unit 54 determines whether or not the instruction to generate the electronic document is received from the user authenticated in step S10. In a case where the instruction to generate the electronic document is not received, the process ends. In a case where the instruction to generate the electronic document is received, the process proceeds to step S14.

In step S14, the electronic document generation unit 54 generates the electronic document in response to the instruction from the user authenticated in step S10. Then, the electronic document generation unit 54 transmits the generated electronic document to the document management server 16 and stores the electronic document in the document management server 16.

In step S16, the transaction creation unit 58 generates the document generation transaction 34a related to the instruction to generate the electronic document received in step S12. As shown in FIG. 4, the document generation transaction 34a includes the transaction ID decided by the transaction creation unit 58, the user ID of the user (that is, the generation user) authenticated in step S10, the document generation transaction flag, and the like.

In step S18, the transaction creation unit 58 simultaneously transmits the document generation transaction 34a generated in step S14 to the plurality of nodes 12a included in the blockchain system 12. As a result, the document generation transaction 34a is recorded in the blockchain 30.

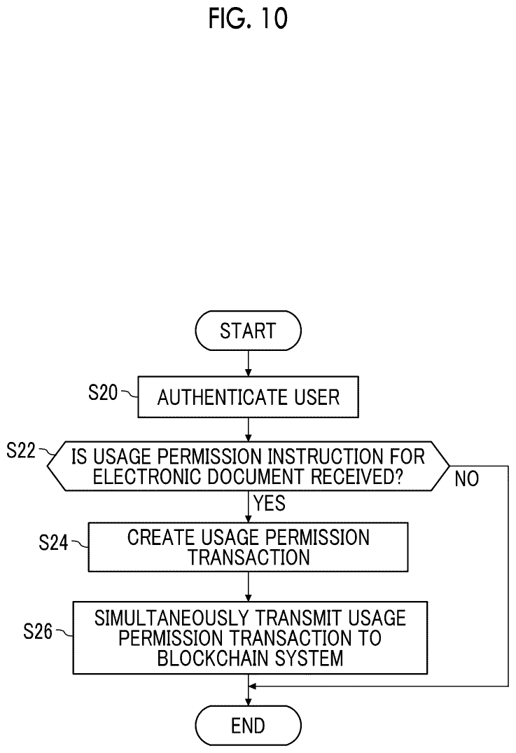

FIG. 10 is a flowchart showing a flow of a process in which the image processing device 14 or the document management server 16 creates and transmits the usage permission transaction 34b. Hereinafter, a flow of an example in which the image processing device 14 generates the usage permission transaction 34b will be described.

In step S20, the authentication processing unit 52 authenticates the user. As a result, the authentication processing unit 52 acquires the user ID of the user.

In step S22, the usage permission processing unit 56 determines whether or not to receive the usage permission instruction for permitting another user to use the electronic document stored in the document management server 16 from the user authenticated in step S10. The usage permission instruction includes the document ID of the electronic document related to the usage permission and the user ID of the usage user. In a case where the usage permission instruction is not received, the process ends. In a case where the usage permission instruction is received, the process proceeds to step S24.

In step S24, the transaction creation unit 58 generates the usage permission transaction 34b related to the usage permission instruction received in step S22. As shown in FIG. 5, the usage permission transaction 34b includes the transaction ID decided by the transaction creation unit 58, the document ID included in the usage permission instruction, the user ID of the user (that is, the permission user) authenticated in step S10, the user ID of the usage user included in the usage permission instruction, the parent transaction ID, and the like.

In step S26, the transaction creation unit 58 simultaneously transmits the usage permission transaction 34b generated in step S24 to the plurality of nodes 12a included in the blockchain system 12. As a result, the usage permission transaction 34b is recorded in the blockchain 30.

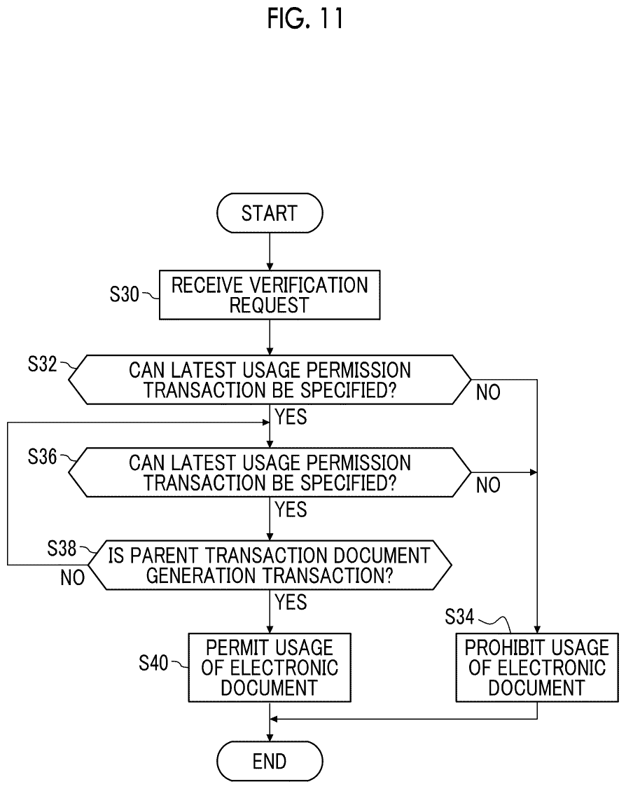

FIG. 11 is a flowchart showing a flow of the verification process of the verification server 18.

In step S30, the verification server 18 receives the verification request from the document management server 16 that receives the usage request for the electronic document managed by the document management server 16 from the user.

In step S32, the verification processing unit 88 specifies the latest usage permission transaction 34b from the transactions 34 included in the block 32 already added to the blockchain 30. In a case where the verification processing unit 88 cannot specify the latest usage permission transaction 34b, the process proceeds to step S34. In step S34, the verification processing unit 88 does not permit the user to use the electronic document. The verification processing unit 88 transmits the verification result to the document management server 16, and the document management server 16 notifies the user of the verification result. In a case where the verification processing unit 88 can specify the latest usage permission transaction 34b, the process proceeds to step S36.

In step S36, the verification processing unit 88 specifies the transaction 34 including the parent transaction ID included in the latest usage permission transaction 34b specified in step S32 as the transaction ID from the transactions 34 included in the block 32 already added to the blockchain 30. In a case where such a transaction 34 is not in the blockchain 30 and the parent transaction cannot be specified, the process proceeds to step S34. In a case where the parent transaction can be specified, the process proceeds to step S38.

In step S38, the verification processing unit 88 determines whether or not the parent transaction is the document generation transaction 34a based on whether or not the parent transaction specified in step S36 includes the document generation transaction flag. In a case where the parent transaction is not the document generation transaction 34a, that is, in a case where the parent transaction is the usage permission transaction 34b, the process returns to step S36. In step S36 again, the verification processing unit 88 specifies the parent transaction specified in previous step S36.

As described above, the verification processing unit 88 repeats the processes of steps S36 to S38 until the specified parent transaction is the document generation transaction 34a, and repeats the process of specifying the parent transaction. In the middle of the process, in a case where the parent transaction cannot be specified, the process proceeds to step S34.

In a case where the parent transaction specified in step S36 is the document generation transaction 34a, the process proceeds to step S40.

In step S40, the verification processing unit 88 permits the user to use the electronic document. The verification processing unit 88 transmits the verification result to the document management server 16, and the document management server 16 notifies the user of the verification result. As a result, the user can use the electronic document.

Although the exemplary embodiment according to the present invention has been described above, the present invention is not limited to the exemplary embodiment and can be subjected to various changes without departing from the gist of the present invention.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

An electronic document management system comprising:
a plurality of devices that each store a distributed ledger and are communicably connected to each other; and
a transaction generation device that includes a first processor and generates a transaction recorded in the distributed ledger,
wherein the first processor is configured to:
   generate a document generation transaction in a case where an electronic document is generated and stored in a document management server, the document generation transaction including a document ID for uniquely identifying the electronic document, a transaction ID for uniquely identifying the document generation transaction, and information indicating that the document generation transaction is the document generation transaction; transmit the document generation transaction to the plurality of devices and record the document generation transaction in the distributed ledger;
   generate a usage permission transaction in response to a usage permission instruction for permitting a usage user to use the electronic document stored in the document management server, the usage permission transaction including the document ID of the electronic document, a transaction ID for uniquely identifying the usage permission transaction, a usage user ID for uniquely identifying the usage user, a usage permission time at which the usage permission instruction is received, and a parent transaction ID for uniquely identifying a parent transaction that is a transaction related to another process executed on the electronic document related to the usage permission instruction immediately before the usage permission instruction; and
   transmit the usage permission transaction to the plurality of devices and record the usage permission transaction in the distributed ledger.
      (((2)))

The electronic document management system according to (((1)
wherein the document generation transaction further includes a generation user ID for uniquely identifying a generation user who gives an instruction to generate the electronic document, and
the first processor is configured to:
   set the transaction ID of the document generation transaction including a document ID identical to the document ID of the electronic document related to the usage permission instruction and the generation user ID identical to a user ID of a permission user who gives the usage permission instruction, as the parent transaction ID, in response to the usage permission instruction.
      (((3)))

The electronic document management system according to (((2))),
wherein the first processor is configured to:
set the transaction ID of the usage permission transaction including the document ID identical to the document ID of the electronic document related to the usage permission instruction and the usage user ID identical to the user ID of the permission user who gives the usage permission instruction, as the parent transaction ID, in response to the usage permission instruction.
   (((4)))

The electronic document management system according to any one of (((1))) to (((3))), further comprising:
a verification device including a second processor,
wherein the second processor is configured to:
   specify a latest usage permission transaction that is a latest usage permission transaction including the document ID of the electronic document and a user ID of the usage user as the usage user in the distributed ledger in response to a usage request for the electronic document from the usage user; and
   permit the usage user to use the electronic document in a case where the parent transaction is traced with the latest usage permission transaction as a starting point based on the parent transaction ID included in the usage permission transaction in the distributed ledger and the document generation transaction of the electronic document is reached.
      (((5)))

The electronic document management system according to (((4))),
wherein the first processor is configured to:
   generate a cancellation transaction including the transaction ID of the usage permission transaction related to a cancellation instruction for the usage permission instruction as a cancellation transaction ID in response to the cancellation instruction; and
   transmit the cancellation transaction to the plurality of devices and record the cancellation transaction in the distributed ledger, and
the second processor is configured to:
   not permit the usage user to use the electronic document in a case where the parent transaction is traced with the latest usage permission transaction as a starting point in response to the usage request for the electronic document from the usage user, and the usage permission transaction having the transaction ID identical to the cancellation transaction ID is searched for in the traced usage permission transaction.
      (((6)))

An electronic document management program causing a computer to execute a process comprising:
generating a document generation transaction in a case where an electronic document is generated and stored in a document management server, the document generation transaction including a document ID for uniquely identifying the electronic document, a transaction ID for uniquely identifying the document generation transaction, and information indicating that the document generation transaction is the document generation transaction;
transmitting the document generation transaction to a plurality of devices that each store a distributed ledger and are communicably connected to each other and recording the document generation transaction in the distributed ledger;
generating a usage permission transaction in response to a usage permission instruction for permitting a usage user to use the electronic document stored in the document management server, the usage permission transaction including the document ID of the electronic document, a transaction ID for uniquely identifying the usage permission transaction, a usage user ID for uniquely identifying the usage user, a usage permission time at which the usage permission instruction is received, and a parent transaction ID for uniquely identifying a parent transaction that is a transaction related to another process executed on the electronic document related to the usage permission instruction immediately before the usage permission instruction; and
transmitting the usage permission transaction to the plurality of devices and record the usage permission transaction in the distributed ledger.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic document management system comprising:
a plurality of devices that each store a distributed ledger and are communicably connected to each other; and
a transaction generation device that includes a first processor and generates a transaction recorded in the distributed ledger,
wherein the first processor is configured to:
generate a document generation transaction in a case where an electronic document is generated and stored in a document management server, the document generation transaction including a document ID for uniquely identifying the electronic document, a transaction ID for uniquely identifying the document generation transaction, and information indicating that the document generation transaction is the document generation transaction;
transmit the document generation transaction to the plurality of devices and record the document generation transaction in the distributed ledger;
generate a usage permission transaction in response to a usage permission instruction for permitting a usage user to use the electronic document stored in the document management server, the usage permission transaction including the document ID of the electronic document, a transaction ID for uniquely identifying the usage permission transaction, a usage user ID for uniquely identifying the usage user, a usage permission time at which the usage permission instruction is received, and a parent transaction ID for uniquely identifying a parent transaction that is a transaction related to another process executed on the electronic document related to the usage permission instruction immediately before the usage permission instruction; and
transmit the usage permission transaction to the plurality of devices and record the usage permission transaction in the distributed ledger.

2. The electronic document management system according to claim 1,
wherein the document generation transaction further includes a generation user ID for uniquely identifying a generation user who gives an instruction to generate the electronic document, and
the first processor is configured to:
set the transaction ID of the document generation transaction including a document ID identical to the document ID of the electronic document related to the usage permission instruction and the generation user ID identical to a user ID of a permission user who gives the usage permission instruction, as the parent transaction ID, in response to the usage permission instruction.

3. The electronic document management system according to claim 2,
wherein the first processor is configured to:
set the transaction ID of the usage permission transaction including the document ID identical to the document ID of the electronic document related to the usage permission instruction and the usage user ID identical to the user ID of the permission user who gives the usage permission instruction, as the parent transaction ID, in response to the usage permission instruction.

4. The electronic document management system according to claim 1, further comprising:
a verification device including a second processor,
wherein the second processor is configured to:
specify a latest usage permission transaction that is a latest usage permission transaction including the document ID of the electronic document and a user ID of the usage user as the usage user in the distributed ledger in response to a usage request for the electronic document from the usage user; and
permit the usage user to use the electronic document in a case where the parent transaction is traced with the latest usage permission transaction as a starting point based on the parent transaction ID included in the usage permission transaction in the distributed ledger and the document generation transaction of the electronic document is reached.

5. The electronic document management system according to claim 2, further comprising:
a verification device including a second processor,
wherein the second processor is configured to:
specify a latest usage permission transaction that is a latest usage permission transaction including the document ID of the electronic document and a user ID of the usage user as the usage user in the distributed ledger in response to a usage request for the electronic document from the usage user; and
permit the usage user to use the electronic document in a case where the parent transaction is traced with the latest usage permission transaction as a starting point based on the parent transaction ID included in the usage permission transaction in the distributed ledger and the document generation transaction of the electronic document is reached.

6. The electronic document management system according to claim 3, further comprising:
a verification device including a second processor,
wherein the second processor is configured to:
specify a latest usage permission transaction that is a latest usage permission transaction including the document ID of the electronic document and a user ID of the usage user as the usage user in the distributed ledger in response to a usage request for the electronic document from the usage user; and
permit the usage user to use the electronic document in a case where the parent transaction is traced with the latest usage permission transaction as a starting point based on the parent transaction ID included in the usage permission transaction in the distributed ledger and the document generation transaction of the electronic document is reached.

7. The electronic document management system according to claim 4,
wherein the first processor is configured to:
generate a cancellation transaction including the transaction ID of the usage permission transaction related to a cancellation instruction for the usage permission instruction as a cancellation transaction ID in response to the cancellation instruction; and
transmit the cancellation transaction to the plurality of devices and record the cancellation transaction in the distributed ledger, and
the second processor is configured to:
not permit the usage user to use the electronic document in a case where the parent transaction is traced with the latest usage permission transaction as a starting point in response to the usage request for the electronic document from the usage user, and the usage permission transaction having the transaction ID identical to the cancellation transaction ID is searched for in the traced usage permission transaction.

8. The electronic document management system according to claim 5,
wherein the first processor is configured to:
generate a cancellation transaction including the transaction ID of the usage permission transaction related to a cancellation instruction for the usage permission instruction as a cancellation transaction ID in response to the cancellation instruction; and
transmit the cancellation transaction to the plurality of devices and record the cancellation transaction in the distributed ledger, and
the second processor is configured to:
not permit the usage user to use the electronic document in a case where the parent transaction is traced with the latest usage permission transaction as a starting point in response to the usage request for the electronic document from the usage user, and the usage permission transaction having the transaction ID identical to the cancellation transaction ID is searched for in the traced usage permission transaction.

9. The electronic document management system according to claim 6,
wherein the first processor is configured to:
generate a cancellation transaction including the transaction ID of the usage permission transaction related to a cancellation instruction for the usage permission instruction as a cancellation transaction ID in response to the cancellation instruction; and
transmit the cancellation transaction to the plurality of devices and record the cancellation transaction in the distributed ledger, and
the second processor is configured to:
not permit the usage user to use the electronic document in a case where the parent transaction is traced with the latest usage permission transaction as a starting point in response to the usage request for the electronic document from the usage user, and the usage permission transaction having the transaction ID identical to the cancellation transaction ID is searched for in the traced usage permission transaction.

10. A non-transitory computer readable medium storing an electronic document management program causing a computer to execute a process comprising:
generating a document generation transaction in a case where an electronic document is generated and stored in a document management server, the document generation transaction including a document ID for uniquely identifying the electronic document, a transaction ID for uniquely identifying the document generation transaction, and information indicating that the document generation transaction is the document generation transaction;
transmitting the document generation transaction to a plurality of devices that each store a distributed ledger and are communicably connected to each other and recording the document generation transaction in the distributed ledger;
generating a usage permission transaction in response to a usage permission instruction for permitting a usage user to use the electronic document stored in the document management server, the usage permission transaction including the document ID of the electronic document, a transaction ID for uniquely identifying the usage permission transaction, a usage user ID for uniquely identifying the usage user, a usage permission time at which the usage permission instruction is received, and a parent transaction ID for uniquely identifying a parent transaction that is a transaction related to another process executed on the electronic document related to the usage permission instruction immediately before the usage permission instruction; and
transmitting the usage permission transaction to the plurality of devices and record the usage permission transaction in the distributed ledger.

11. An electronic document management method comprising:
generating a document generation transaction in a case where an electronic document is generated and stored in a document management server, the document generation transaction including a document ID for uniquely identifying the electronic document, a transaction ID for uniquely identifying the document generation transaction, and information indicating that the document generation transaction is the document generation transaction;
transmitting the document generation transaction to a plurality of devices that each store a distributed ledger and are communicably connected to each other and recording the document generation transaction in the distributed ledger;
generating a usage permission transaction in response to a usage permission instruction for permitting a usage user to use the electronic document stored in the document management server, the usage permission transaction including the document ID of the electronic document, a transaction ID for uniquely identifying the usage permission transaction, a usage user ID for uniquely identifying the usage user, a usage permission time at which the usage permission instruction is received, and a parent transaction ID for uniquely identifying a parent transaction that is a transaction related to another process executed on the electronic document related to the usage permission instruction immediately before the usage permission instruction; and
transmitting the usage permission transaction to the plurality of devices and record the usage permission transaction in the distributed ledger.
